(19) United States
(12) Patent Application Publication
(10) Pub. No.: US 2023/0388180 A1
(43) Pub. Date: Nov. 30, 2023

(54) TECHNIQUES FOR PROVISIONING WORKSPACES IN CLOUD-BASED COMPUTING PLATFORMS

(71) Applicant: Microsoft Technology Licensing, LLC, Redmond, WA (US)

(72) Inventors: Veerash Ayyagari, Redmond, WA (US); Ullas Narasimha KUMBLE, Issaquah, WA (US)

(21) Appl. No.: 17/829,235

(22) Filed: May 31, 2022

(51) Int. Cl. H04L 41/0806; H04L 41/22; H04L 41/5041

(52) U.S. Cl. CPC H04L 41/0806; H04L 41/22; H04L 41/5045; H04L 67/10

(57) ABSTRACT

Described are examples for provisioning resources on a cloud-based computing platform including receiving, from a user interface, a visual representation of a desired workspace configuration including multiple resources to be deployed on the cloud-based computing platform, translating the visual representation into a data representation including name/value pairs, deploying, based on the data representation, the multiple resources on one or more nodes of the cloud-based computing platform, and providing, to the user interface, an indication of one or more parameters for accessing the multiple resources via the cloud-based computing platform.

### BACKGROUND

Many enterprises are shifting strategy from running physical infrastructure to running virtual infrastructure on public/private cloud-based computing platforms. This shift provides an advantage of being able to describe the desired state of Infrastructure as Code (IaC). While IaC is a concept with tremendous advantages, it is not a solution that fits all use cases. For example, IaC requires enterprises to have a team of subject matter experts (SMEs) to ensure the IaC artifacts are represented according pre-defined standards and guidelines. Also, orchestrating deployment workflows using IaC, such as installing applications into a virtual machine post provisioning or setting up inbound/outbound access through a security system, etc., requires writing automation scripts and extensive knowledge of the hosting provider. In addition, in IaC, there is no abstraction between the end user and the hosting provider where the infrastructure is provisioned. Rather, every user who is working on provisioning or orchestrating infrastructure is supposed to learn the underlying IaC representations provided by the hosting platforms. This can become even more complicated when an enterprise hosts infrastructure on multiple hosting providers or switches between providers. Additionally, in IaC, it may not be possible to enforce resource governance and/or security compliance through an IaC artifact.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an example, a computer-implemented method for provisioning resources on a cloud-based computing platform is provided that includes receiving, from a user interface, a visual representation of a desired workspace configuration including multiple resources to be deployed on the cloud-based computing platform, translating the visual representation into a data representation including name/value pairs, deploying, based on the data representation, the multiple resources on one or more nodes of the cloud-based computing platform, and providing, to the user interface, an indication of one or more parameters for accessing the multiple resources via the cloud-based computing platform.

In another example, a device for provisioning resources on a cloud-based computing platform is provided that includes a memory storing instructions, and at least one processor coupled to the memory. The at least one processor is configured to receive, from a user interface, a visual representation of a desired workspace configuration including multiple resources to be deployed on the cloud-based computing platform, translate the visual representation into a data representation including name/value pairs, deploy, based on the data representation, the multiple resources on one or more nodes of the cloud-based computing platform, and provide, to the user interface, an indication of one or more parameters for accessing the multiple resources via the cloud-based computing platform.

In another example, a computer-readable medium storing instructions thereon that, when executed by at least one computing device, causes the at least one computing device to perform operations for provisioning resources on a cloud-based computing platform is provided. The operations include receiving, from a user interface, a visual representation of a desired workspace configuration including multiple resources to be deployed on the cloud-based computing platform, translating the visual representation into a data representation including name/value pairs, deploying, based on the data representation, the multiple resources on one or more nodes of the cloud-based computing platform, and providing, to the user interface, an indication of one or more parameters for accessing the multiple resources via the cloud-based computing platform.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for performing functions related to performing functions related to deploying resources in a cloud-based computing platform, in accordance with aspects described herein.

FIG. 2 illustrates an example of a resource managing component, in accordance with some aspects described herein.

FIG. 3 illustrates an example of a resource governance component, in accordance with some aspects described herein.

FIG. 4 illustrates an example of a resource compliance component, in accordance with some aspects described herein.

FIG. 5 is a flow diagram of an example of a method for deploying resources based on a desired workspace configuration, in accordance with aspects described herein.

FIG. 6 illustrates an example of a graphical user interface for specifying a desired workspace configuration, in accordance with aspects described herein.

FIG. 7 is a flow diagram of an example of a method for managing deployed resources on a cloud-based computing platform, in accordance with aspects described herein.

FIG. 8 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to provisioning workspaces on a cloud-based computing platform by providing a user interface that enables defining a desired workspace configuration. A workspace provisioning architecture can interpret the desired workspace configuration, and can automatically provision the resources over a cloud-based computing platform. For example, the workspace provisioning architecture can deploy the resources on one or more nodes of the cloud-based computing platform, where the resources can include virtual machines (VMs), disk or memory or other persistent or non-persistent storage resources, network interface card (NIC) resources, platform as a services (PaaS) website, or other server-based or serverless functions. In addition, for example, the workspace provisioning architecture can provide (e.g., to or via the user interface) information for accessing the resources, such as a network location or address, credential information, etc. In another example, the user interface can enable defining connectivity between the resources, and the workspace provisioning architecture can accordingly establish a connection between deployed resources and/or underlying nodes that host the resources (e.g., by opening or managing one or more network ports between the deployed resources and/or underlying nodes).

Using the workspace provisioning architecture to interpret a more generalized desired workspace configuration in this regard can allow for much of the work required to establish Infrastructure as Code (IaC) to be offloaded from end users to computing resources. In some examples, the user interface can provide a what you see is what you get (WYSIWYG) type of user interface where the users can define the infrastructure and communications patterns (e.g., by drag and drop workspaces, drawing connectivity lines between the workspaces, etc.) without having knowledge of the underlying hosting platform. In this example, the workspace provisioning architecture can provision and orchestrate, based on the desired workspace configuration, infrastructure across nodes (e.g., in one or more data centers) in the cloud-based computing environment. In examples described herein, workspace provisioning architecture can deploy the resources in a cost efficient and secure manner, enforce user quota governance and security compliance requirements, provide maintenance operations for the computing resources that host the resources (and/or for the resources), etc.

In addition, the benefits of using the user interface to define the desired workspace configuration can extend to various personas across the enterprise, such as Infrastructure and Security Administrators that can allocate quotas for resource governance and security policies for compliance, DevOps Engineers that can more easily build, templatize, provision and orchestrate performance and test lab environments, Customer Support Engineers/Field Engineers that can more easily templatize and provision complex environments in a short period of time, Trainers that can provision repeatable lab environments for training without worrying about writing complex scripts and understanding the underlying hosting provider, etc.

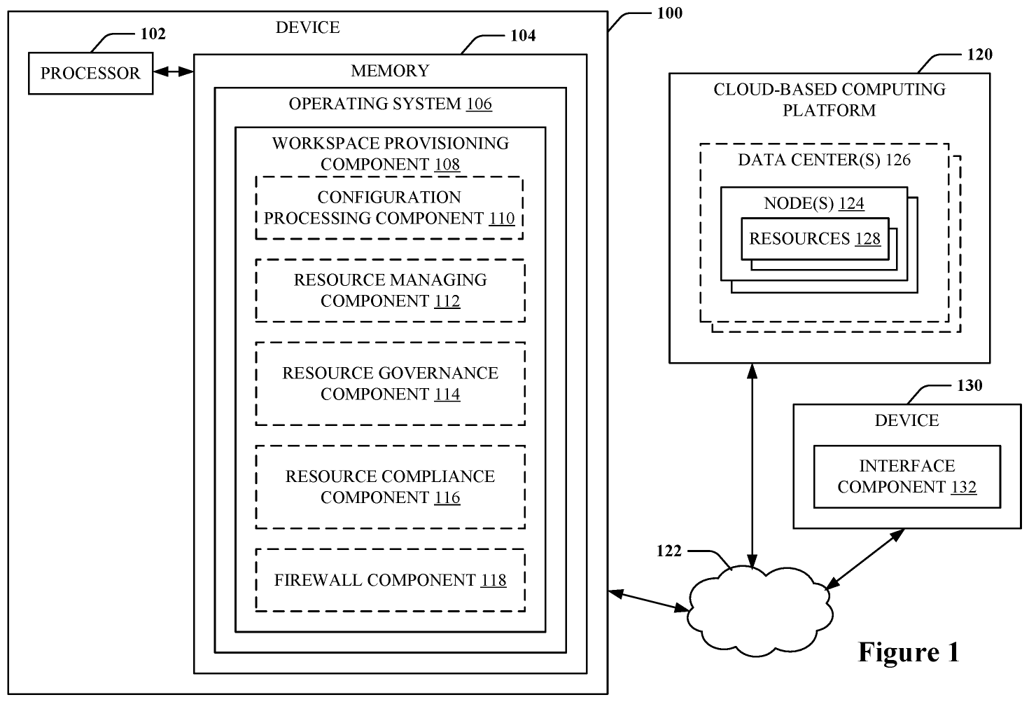

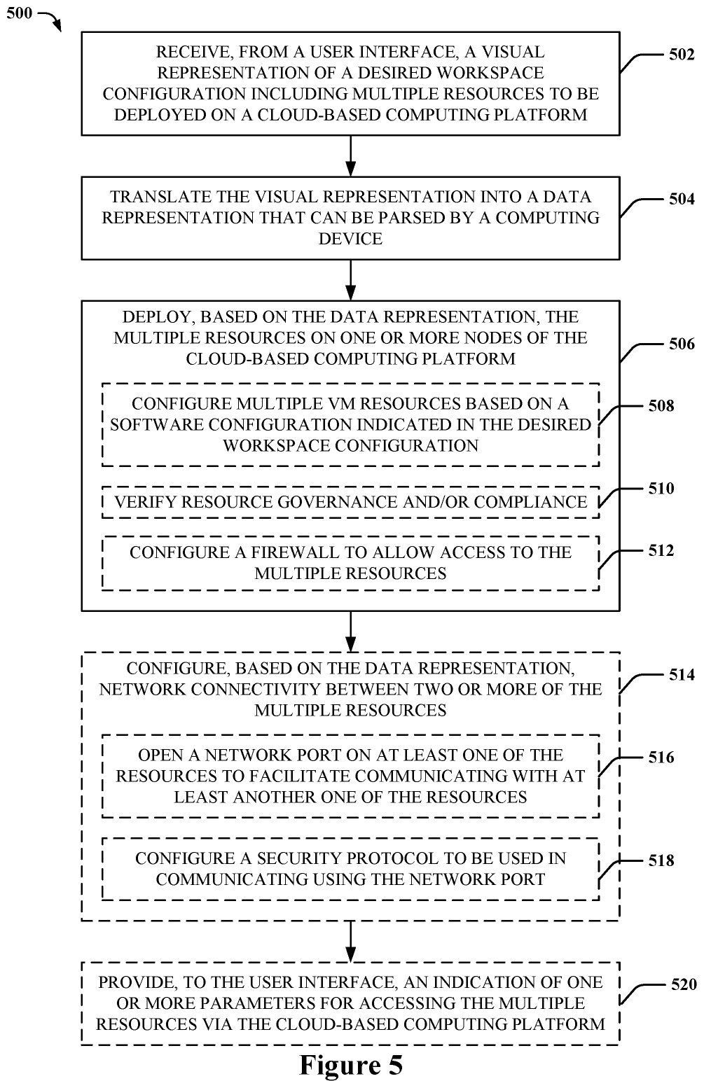

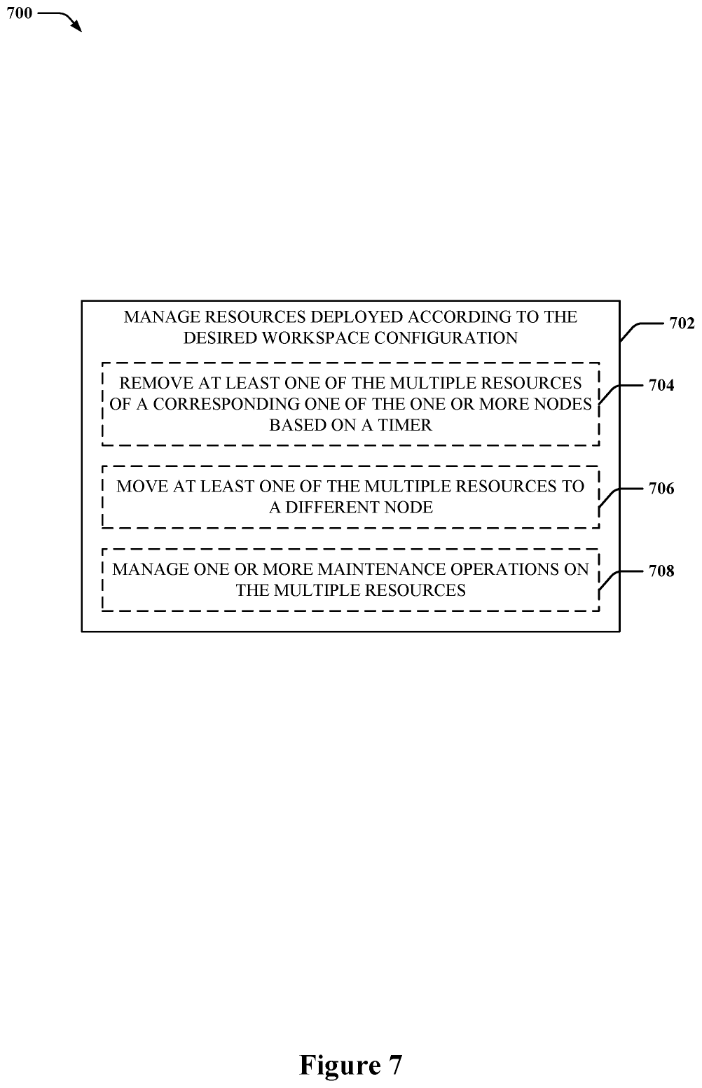

Turning now to FIGS. 1-8 examples are depicted with reference to one or more components and one or more methods that may perform the actions or operations described herein, where components and/or actions/operations in dashed line may be optional. Although the operations described below in FIGS. 5 and 7 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a schematic diagram of an example of a device 100 (e.g., a computing device) for performing functions related to deploying resources in a cloud-based computing platform. In an example, device 100 can include a processor 102 and/or memory 104 configured to execute or store instructions or other parameters related to providing an operating system 106, which can execute one or more applications or processes, such as, but not limited to, a workspace provisioning component 108 for deploying resources, managing connectivity between the resources, and/or the like based on a desired workspace configuration. For example, processor 102 and memory 104 may be separate components communicatively coupled by a bus (e.g., on a motherboard or other portion of a computing device, on an integrated circuit, such as a system on a chip (SoC), etc.), components integrated within one another (e.g., processor 102 can include the memory 104 as an on-board component), and/or the like. Memory 104 may store instructions, parameters, data structures, etc. for use/execution by processor 102 to perform functions described herein.

For example, workspace provisioning component 108 can include a configuration processing component 110 for obtaining and/or processing a desired workspace configuration that indicates multiple resources to deploy in a cloud-based computing platform and/or related information, such as software to be deployed, connectivity between the resources, and/or the like, and a resource managing component 112 for managing one or more aspects of the deployed resources, such as software to be installed, nodes on which the resources are deployed, maintenance operations, etc. In an example, resource managing component 112 can also be configured for establishing and/or managing connectivity between the resources and/or between the underlying nodes, etc. In an example, workspace provisioning component 108 can include one or more of a resource governance component 114 for maintaining information with respect to quotas based on cost, utilization, access, etc., which can be used to enhance runtime analytics of the resource provisioning. In another example, workspace provisioning component 108 can include a resource compliance component 116 for maintaining information with respect to allowed deployment methods or patterns, allowed access patterns, system or security patch or update procedure parameters, such as duration, etc., which can be used to enhance runtime analytics of the resource provisioning and/or updating. In another example, workspace provisioning component 108 can include a firewall component 118 for allowing or blocking access to the provisioned resources, which may be based on user authentication, internet protocol (IP) address, port number, allowed time duration for accessing the resources, etc., to provide a level of security for the provisioned resources. In an example, device 100 can communicate with a cloud-based computing platform 120, and/or one or more nodes thereof, via one or more networks 122.

In an example, cloud-based computing platform 120 can include multiple nodes 124, which can be physically located at various geographic locations, and can communicate with one another and/or be configured on the same network or subnet. In an example, the multiple nodes 124 can be present in one or more data centers 126 that in a physical location and including various nodes 124. For example, the data centers 126 can be located in various geographical regions and configured on the same network or subnet to allow for reducing latency for users in the geographical region while providing a single access point for the cloud-based computing platform 120. In addition, for example, each node 124 can initialize one or more resources 128 to provide services in the cloud-based computing platform 120, and one or more client devices can access the one or more resources 128, or corresponding services, via the one or more networks 122. For example, resources 128 can include resources provisioned as part of the workspace provisioning, such as VMs, disk resources, NIC resources, PaaS, etc., as described. In an example, the VM resources may process one or more workloads that may also be indicated in the desired workspace configuration,

In an example, workspace provisioning component 108 can access resources of the cloud-based computing platform 120 via the one or more networks 122. For example, workspace provisioning component 108 can deploy resources on one or more VMs 128 of one or more nodes 124 of the cloud-based computing platform 120. In some examples, resource managing component 112 can consider a desired region, resource policy, etc. in selecting nodes 124 over which to deploy resources, as described further herein. Each node 124 can also include a processor 102, memory 104, etc., which are not shown for ease of explanation.

In an example, a device 130 can provide an interface component 132 to allow for indicating, via a user interface, the desired workspace configuration. For example, the interface component 132 can provide a user interface with which a user of device 130 can interact to define the desired workspace configuration. Based on the input via the user interface, interface component 132 can generate an interpreted language version of the desired workspace configuration (e.g., using a markup language) for providing to the workspace provisioning component 108. In an example, workspace provisioning component 108 can process the interpreted language version of the desired workspace configuration, and can accordingly deploy and/or manage resources or related connectivity via the cloud-based computing platform 120.

In an example, the interface component 132 can include a workspace portal, which can include an interface that allows defining a desired workspace configuration, as described above and further herein. Accordingly, the workspace portal can be accessed by a user to specify the desired workspace configuration, to modify an existing workspace configuration, and/or the like. In one specific example, a user can request provisioning of resources using the workspace portal, which can be provided on an interface accessible via a web browser, or can be provided via a backend application programing interface (API) accessible using a different application, etc. The workspace portal (and/or user) can be authenticated or authorized to access the cloud-based computing platform 120 for deploying resources based on security provisioning provided by the cloud-based computing platform 120.

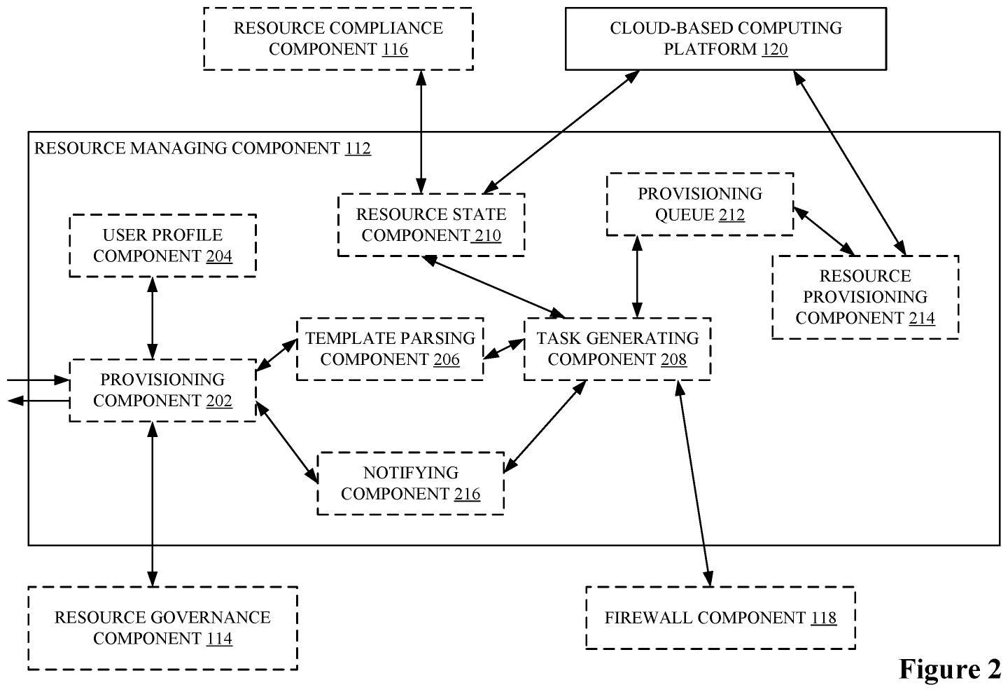

FIG. 2 illustrates an example of a resource managing component 112 in accordance with some aspects described herein. Resource managing component 112 can communicate with one or more of a resource governance component 114, resource compliance component 116, firewall component 118, cloud-based computing platform 120, etc. For example, the components 114, 116, 118 may be part of the same device as resource managing component 112 or a different device, with which the device hosting resource managing component 112 can communicate. Thus, as described, the components 112, 114, 116, 118 may be distributed among one or more nodes in a network, in one example.

For example, resource managing component 112 can include a provisioning component 202 for receiving a request to provision resources in the cloud-based computing platform 120 according to a desired workspace configuration. For example, provisioning component 202 can receive the request, which can include a representation of the desired workspace configuration that may be translated (e.g., by a configuration processing component 110) from a visual representation to a format that can be parsed by a machine, such as a JavaScript Object Notation (JSON) representation or other name/value pair representation. For example, the provisioning component 202 can communicate with a user profile component 204 to ensure the user requesting the resource provisioning is authorized to create requested workspace configuration in the cloud-based computing platform 120. As such, for example, user profile component 204 can store user profile information for multiple users, along with permissions regarding creating desired workspace configurations for deploying in the cloud-based computing platform 120. In an example, the user can be associated with the desired workspace configuration at the time of creating the desired workspace configuration, such as by accessing interface component 132 using credentials associated with the user profile.

In an example, provisioning component 202 can also communicate with the resource governance component 114 to ensure the user has quota available to provision, such as resource quota maintained for the user regarding resources the user can use in the cloud-based computing platform 120. If not, provisioning component 202 (or resource governance component 114) can checks one or more other back-up regions of the cloud-based computing platform 120 (e.g., outside of a region associated with the user) for available quota. If it finds quota in any of these regions, provisioning component 202 can publish the region and/or associated provisioning information to a template parsing component 206, which may include a queue for storing the JSON representation (or other representation) of the desired workspace configuration for provisioning the associated resources on the cloud-based computing platform 120.

In one example, a task generator component 208 can communicate with the template parsing component 206, or can otherwise subscribe to the associated queue. In this regard, for example, task generating component 208 can detect existence of a desired workspace configuration in the queue, and can allocate one or more processes (e.g., worker threads) to parse the desired workspace configuration and accordingly provision associated resources on the cloud-based computing platform 120. For example, task generating component 208 can communicate with a resource state component 210 to determine or otherwise observe a current state of the infrastructure to determine whether the request is creating new set of resources or updating an existing set of resources on the cloud-based computing platform 120. After Identifying the resources to be created/modified, for example, task generating component 208 can communicate with the resource state component 210 to retrieve a desired configuration to be provisioned for the requested resources. As described, for example, the resources can correspond to VMs (or associated workloads), disk resources, NIC resources, PaaS website, other server-based or serverless functions, etc. In an example, resource state component 210 can communicate with resource compliance component 116, as described further herein, to get compliance state configuration as well, which can create a best practice desired state configuration for the resource being provisioned.

In an example, based on the desired state information for each resource that is part of the template, task generating component 208 can determine the tasks (or worker threads) that can run in parallel and tasks (or worker threads) to run in sequence to provision the resources as indicated in the desired workspace configuration. Task generating component 208, in one example, can appropriately group the serial tasks and parallel tasks appropriately and publish them to a provisioning queue 212. A resource provisioning component 214 can subscribe to the provisioning queue 212, or can otherwise receive the resource information from task generating component 208. The resource provisioning component 214, for example, can create, modify, delete, etc. the resources on the cloud-based computing platform based on the task definition it receives from the provisioning queue 212.

In one example, resource state component 210 can subscribe to any changes to resources in the cloud-based computing platform 120 and can update the current state of infrastructure. The task generating component 208, in an example, can utilize the state information to determine whether a template provisioning request for a desired workspace configuration has completed or failed. If Successful, task generating component 208 can configure the firewall component 118 with appropriate access to the user and/or as associated with one or more of an IP address, port number, etc. for the user. In an example, task generating component 208 can publish this information to a notifying component 216 for informing the user that the requested infrastructure (e.g., the desired workspace configuration) has been successfully provisioned. In one example, provisioning component 202 can subscribe to the notifying component 216 or an associated notification queue, and can publish this information to the user (e.g., via interface component 132 or other notification mechanism). The user can accordingly access the deployed resources based on the access information via firewall component 118.

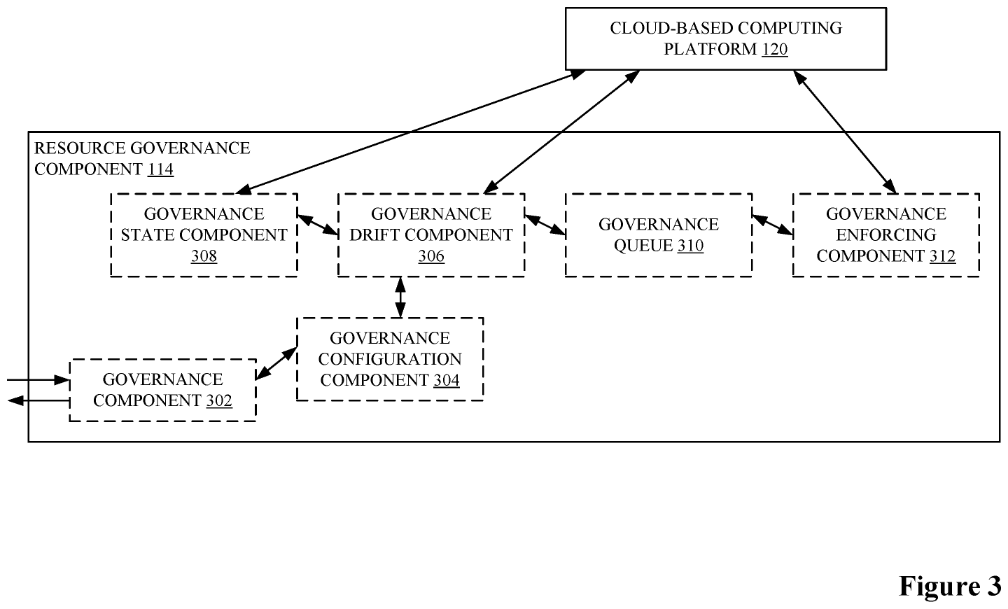

FIG. 3 illustrates an example of a resource governance component 114 in accordance with some aspects described herein. Resource governance component 114 can communicate with one or more of a resource provisioning component 112, cloud-based computing platform 120, etc.

For example, resource governance component 114 can include a governance component 302 for receiving a request to verify or perform resource governance for resources in a cloud-based computing platform 120. For example, governance component 302 can look up a base configuration set stored by a governance configuration component 304, and can return the configuration to the component requesting the governance (e.g., a resource provisioning component 112). The base configuration may be based on quota limits with respect to cost, usage, an access, and may be specified on a per-user basis, on a per-corporation or division basis, etc.

In an example, in the background or otherwise as resource provisioning component 112 and/or other components are autonomously executing, a governance drift component 306 can execute using, or otherwise based on, this base configuration. The governance drift component 306 (e.g., via one or more auditor threads) can look up the current state of infrastructure on cloud-based computing platform 120 and can compare it with the base configuration. The governance drift component 306 can also check with the governance state component 308 for any additional real time analytics or improvements that are within quota limits. For example, governance state component 308 may observe usage patterns of the resources provisioned in the cloud-based computing platform, and may activate or deactivate resources, move resources to various nodes for additional performance or to comply with quotas, etc.

For example, based on the information received from governance state component 308, if the governance drift component 306 determines that the current state is to be modified to reach a desired state or quota, governance drift component 306 can publish a message to a governance queue 310 to effectuate the resource modification. A governance enforcing component 312 can include one or more processes (e.g., worker threads) that subscribe to the governance queue 310 and apply the associated resource changes to the existing infrastructure in the cloud-based computing platform 120.

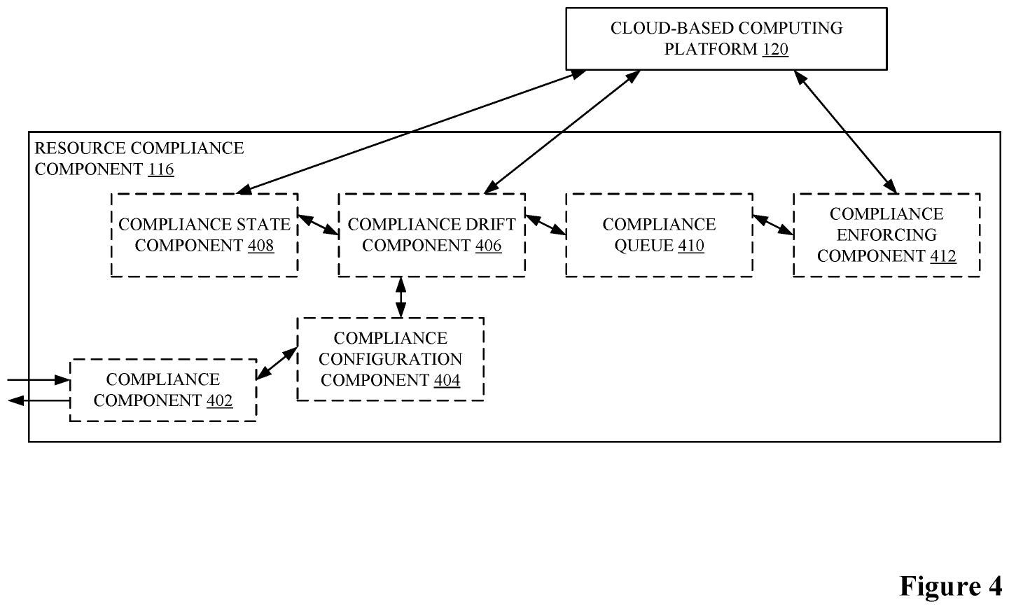

FIG. 4 illustrates an example of a resource compliance component 116 in accordance with some aspects described herein. Resource compliance component 116 can communicate with one or more of a resource provisioning component 112, cloud-based computing platform 120, etc.

For example, resource compliance component 116 can include a compliance component 402 for receiving a request to verify or perform resource compliance for resources in a cloud-based computing platform 120. For example, compliance component 402 can look up a base configuration set stored by a compliance configuration component 404, and can return the configuration to the component requesting the compliance (e.g., a resource provisioning component 112). The base configuration may be based on compliance policies from a security standpoint (e.g., patches, upgrades, access/deployment patterns, etc.), and may be specified on a per-user basis, on a per-corporation or division basis, etc.

In an example, in the background or otherwise as resource provisioning component 112 and/or other components are autonomously executing, a compliance drift component 406 can execute using, or otherwise based on, this base configuration. The compliance drift component 406 (e.g., via one or more auditor threads) can look up the current state of infrastructure on cloud-based computing platform 120 and can compare it with the base configuration. The compliance drift component 406 can also check with the compliance state component 408 for any additional real time analytics or improvements associated with resource compliance (such as blocking anomalous requests or access patterns). For example, compliance state component 408 may observe usage patterns of the resources provisioned in the cloud-based computing platform, and may activate or deactivate resources, move resources to various nodes, control access to the resources, apply updates or patches or other upgrades, etc. to the resources or associated nodes, etc.

For example, based on the information received from compliance state component 408, if the compliance drift component 406 determines that the current state is to be modified for compliance, compliance drift component 406 can publish a message to a compliance queue 410 to effectuate the resource modification. A compliance enforcing component 412 can include one or more processes (e.g., worker threads) that subscribe to the compliance queue 410 and apply the associated resource changes to the existing infrastructure in the cloud-based computing platform 120.

Resources provisioned at an enterprise level can be managed and maintained for governance or compliance based on various customized organization policies. The workspace portal, as described above and which can be provided by the workspace provisioning component 108, can use administration portal or resource governance component 114 or resource compliance component 116 to maintain governance and/or compliance on the provisioned resources based on organization policies and configured key performance indicators.

FIG. 5 is a flowchart of an example of a method 500 for deploying resources based on a desired workspace configuration. For example, method 500 can be performed by a device 100 (and/or additional devices) and/or one or more components thereof (e.g., a workspace provisioning component 108, configuration processing component 110, resource managing component 112, resource governance component 114, resource compliance component 115, firewall component 118, etc., which may be provided by one or more devices) to facilitate deploying and/or managing resources or related connectivity.

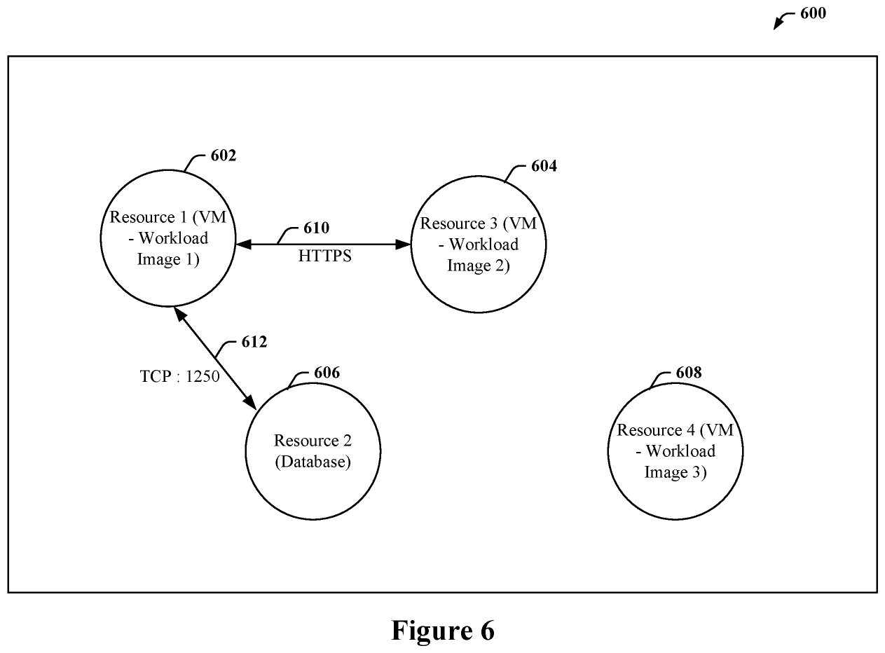

In method 500, at action 502, a visual representation of a desired workspace configuration including multiple resources to be deployed on a cloud-based computing platform can be received from a user interface. In an example, configuration processing component 110 of a workspace provisioning component 108, e.g., in conjunction with processor 102, memory 104, operating system 106, etc., can receive, from the user interface (e.g., from interface component 132 of another device 130 accessible via one or more networks 122), the visual representation of the desired workspace configuration including the multiple resources (e.g., resources 128) to be deployed on the cloud-based computing platform 120. For example, as described, the visual representation of the desired workspace configuration may include an image drawn by a user or otherwise via interface component 132, as described herein. The image may include various indicators of resources, which may include different icons or other indicators for different types of resources (e.g., different icons for VMs, disk resources, NIC resources, PaaS resources, serverless resources, etc.). In addition, in an example, the image may include lines or other indicators that can link the resources and indicate network connectivity between the resources. An example is shown in FIG. 6.

FIG. 6 illustrates an example of a graphical user interface 600 for specifying a visual representation of a desired workspace configuration. For example, graphical user interface 600 can present a drawing canvas or other visual representation via a web browser (e.g., by interface component 132). A user can draw or drag and drop resources, connect the resources with lines, etc. to generate the desired workspace configuration. In other examples, various types of graphical user interfaces may be used, such as an interface with text boxes to allow for defining the resources in the workspace configuration, and selection boxes to allow for specifying connectivity between resources, etc.

In the specific non-limiting example of graphical user interface 600, a user can create the visual representation of the desired workspace configuration by drawing or dragging and dropping a resource indicator 602. The user can assign “Resource 1” to the resource 602, along with one or more other parameters, such as an indication that Resource 1 is a VM that is to be configured with Image 1 software configuration. In an example, the options can be provided using a selection box of possible resource types (e.g., VM, disk, NIC, PaaS, etc.), possible software configurations for VM resources, etc. In addition, the user can create a resource indicator 604, which the user can assign to “Resource 2” along with an indication that Resource 2 is a database resource. In addition, the user can create a resource indicator 606, which the user can assign to “Resource 3” along with an indication that Resource 3 is a VM that is to be configured with Image 2 software configuration. In addition, the user can create a resource indicator 608, which the user can assign to “Resource 4” along with an indication that Resource 4 is a VM that is to be configured with Image 3 software configuration. In an example, a systems administrator or other use can create the selectable software configurations that can be possibly used to configure the VMs in the workspace.

Also, in graphical user interface 600, the user can draw connectivity line 610 or other visual connection for connecting resource 602 and 604, and can specify hypertext transfer protocol secure (HTTPS) as the connectivity type. The user can also draw connectivity line 612 between resource 602 and resource 606, and can specify transmission control protocol (TCP) and port number 1250 as the connectivity type. As described above and further herein, workspace provisioning component 108 can create resources 602, 604, 606, 608 on the cloud-based computing architecture, and can load the software configurations of image 1, image 2, and image 3, on resources 602, 606, and 608, respectively. Workspace provisioning component 108 can also configure the resources 602 and 604 to communicate over HTTPS, and can configure the resources 602 and 606 to communicate over TCP port 1250, as described further herein.

In method 500, at action 504, the visual representation can be translated into a data representation that can be parsed by a computing device. In an example, configuration processing component 110 of a workspace provisioning component 108, e.g., in conjunction with processor 102, memory 104, operating system 106, etc., can translate the visual representation into the data representation that can be parsed by a computing device. For example, configuration processing component 110 can translate the visual representation to a JSON or other representation that can have name/value pairs. For example, the data representation can include an interpreted language version of the desired workspace configuration, which may include a hierarchical specification of various resources to be deployed, relationships or other connectivity between the resources, etc. For example, the data representation may include name/value pairs for each resource, type of resource, other parameters such as an image to be loaded on VMs or other software configuration, an indication of network connectivity between the resources, etc.

In one example, the data representation of the desired workspace configuration can include additional information, obtained from the visual representation, regarding the workspace, such as a workspace name, machine types to be included in the workspace, network for the workspace (e.g., network name, an indication of whether the network is to be routable, etc.), and/or the like. The data representation of the desired workspace configuration may also include information regarding the machines to be configured, such as machine name, operating system, amount of memory, number of NICs, number of data disks, domain role (e.g., domain controller, workgroup member, etc.), software or image version to be deployed on the machine. The data representation of the desired workspace configuration can also include indications of connectivity between machines or related resource, such as a type of connectivity, protocol to be used for the connectivity, and/or the like.

In method 500, at action 506, the multiple resources can be deployed, based on the data representation, on one or more nodes of the cloud-based computing platform. In an example, resource managing component 112 of the workspace provisioning component 108, e.g., in conjunction with processor 102, memory 104, operating system 106, etc., can deploy, based on the data representation, the multiple resources (e.g., resources 128) on the one or more nodes 124 of the cloud-based computing platform 120. For example, resource managing component 112 can select the nodes 124 of the cloud-based computing platform 120 over which to deploy the resources for the desired workspace configuration. Resource managing component 112 can select the nodes 124 in some respects as agnostic to the desired workspace configuration, such that the desired workspace configuration need not indicate the specific nodes 124 over which to deploy the resources. Indeed, in some examples, resource managing component 112 can deploy the resources on different cloud-based computing platforms 120 based on the desired workspace configuration, such that the desired workspace configuration can be agnostic to the cloud-based computing platform 120. In one example, interface component 132 may allow for selection of the cloud-based computing platform 120 on which to deploy the resources. In an example, resource managing component 112 can initialize or deploy the resources (e.g., one or more resources 128) on the one or more nodes for execution via cloud-based computing platform 120.

As described, for example, the desired workspace configuration can indicate various parameters related to the workspace and/or corresponding machines or resources, etc. One parameter may include a geographic deployment region. In this example, resource managing component 112 can select nodes 124 that are within the specified deployment region for deploying the resources. For example, the desired workspace configuration can indicate the deployment region as a country, as a specific data center 126 or collection of data centers, etc. Resource managing component 112 can manage deployment of the resources on the nodes 124 considering the specified deployment region (e.g., by selecting nodes 124 that are geographically located within the region, located with a specified data center 126, etc.).

Another parameter may include a cost or resource quota or other governance parameter. In this example, resource managing component 112, e.g., in conjunction with resource governance component 114, can select nodes 124 that achieve the cost or resource quota, etc. For example, resource managing component 112 can communicate with the resource governance component 114 to determine costs associated with deploying the resources on one or more of the nodes 124, as described above, where the cost may be associated with deployment for a period of time also specified in the desired workspace configuration. In an example, resource managing component 112 may deploy the resources on nodes 124 that allow for staying within the cost or resource quota. For example, some nodes 124 may have more resources than others, or may be reserved to have not as many resources provisioned such to guarantee a quality-of-service (QoS), etc., and resource managing component 112 and/or resource governance component 114 can use this information to determine nodes 124 on which to deploy the resources given a cost or resource quota parameter in the desired workspace configuration. Another parameter may include an amount of memory or data disks, a number of NICs, etc. (e.g., for a given machine). In this example, resource managing component 112 and/or resource governance component 114 can select nodes 124 that have sufficient memory, data disks, number of NICs, etc. to support that indicated in the desired workspace configuration (e.g., for a given machine).

In an example, in deploying the multiple resources at action 506, optionally at action 508, multiple VM resources can be configured based on a software configuration indicated in the desired workspace configuration. In an example, resource managing component 112, e.g., in conjunction with processor 102, memory 104, operating system 106, etc., can configure the multiple VM resources based on the software configuration indicated in the desired workspace configuration. For example, the desired workspace configuration can indicate software packages and/or an image to be loaded for the VM resource. In this example, resource managing component 112 can instantiate the resources 128 including VMs and can deploy the software packages and/or the image to the VMs as indicated in the desired workspace configuration. In an example, resource managing component 112 can execute one or more scripts to install the software, where the scripts can be provided by a systems administrator and can include information for obtaining the software packages and installing the software packages on a target VM. In this regard, for example, resource managing component 112 can determine the node 124 on which to install the resource, initialize a VM on the node 124, and execute the script that is associated with the selected software configuration on the VM to install the software or image. In this regard, for example, the user interface can provide software package or image option(s) for selection for a VM where resource managing component 112 has an associated script(s) to install the software packet or image option(s).

In another example, in deploying the multiple resources at action 506, optionally at action 510, resource governance and/or complied can be verified. In an example, resource managing component 112, resource governance component 114, and/or resource compliance component 116, e.g., in conjunction with processor 102, memory 104, operating system 106, etc., can verify resource governance and/or compliance of the resources (e.g., resources 128) being deployed and/or of other resources for the user, user group to which the user belongs, corporate entity or division, etc. on the cloud-based computing platform 120. In an example, as described above, resource managing component 112, resource governance component 114, and/or resource compliance component 116 can verify resource governance and/or compliance of the resources before deploying the resources or as part of deploying the resources, and/or in background processes after deploying the resources. In an example, resource managing component 112 or resource governance component 114 can verify or enforce quotas or other resource governance parameters in determining nodes 124 on which to deploy the resources 128. Similarly, in an example, resource managing component 112 or resource compliance component 116 can verify or enforce resource compliance (e.g., manage access to the resources 128, apply patches or upgrades to the resources, etc.).

In another example, in deploying the multiple resources at action 506, optionally at action 512, a firewall can be configured to allow access to the multiple resources. In an example, resource managing component 112 and/or firewall component 118, e.g., in conjunction with processor 102, memory 104, operating system 106, etc., can configure the firewall to allow access to the multiple resources (e.g., resources 128). In an example, the firewall can be part of the cloud-based computing platform 120 or can otherwise communicate with the cloud-based computing platform 120 to facilitate accessing resources 128 and/or associated nodes 124. In an example, after the multiple resources 128 are deployed in the cloud-based computing platform 120, as specified in the desired workspace configuration, firewall component 118 can configure the firewall to allow the user that submitted the desired workspace configuration to access the corresponding resources 128.

In method 500, at action 514, network connectivity can be configured between two or more of the multiple resources can be configured, based on the data representation. In an example, resource managing component 112 of the workspace provisioning component 108, e.g., in conjunction with processor 102, memory 104, operating system 106, etc., can configure, based on the data representation, network connectivity between the two or more of the multiple resources (e.g., resources 128). For example, the desired workspace configuration may indicate one or more of network connectivity between two resources, a protocol to be used for the network connectivity (e.g., hypertext transfer protocol (HTTP), HTTPS, TCP, TCP/internet protocol (IP), file transfer protocol (FTP), etc.), a security protocol to be used for the network connectivity, (e.g., secure socket layer (SSL), transport socket layer (TLS), etc.), and/or the like. For example, resource managing component 112 can setup the network port as indicated in the desired workspace configuration.

In an example, in configuring the network connectivity at action 514, optionally at action 516, a network port on at least one of the resources can be opened to facilitate communicating with at least another one of the resources. In an example, resource managing component 112 of the workspace provisioning component 108, e.g., in conjunction with processor 102, memory 104, operating system 106, etc., can open the network port on at least one of the resources to facilitate communicating with at least another one of the resources. In an example, connectivity component 116 can open a network port on a first one of the resources 128 and/or on the node 124, and/or can provide information regarding the open port to a second one of the resources 128 to enable communications between the first one of the resources 128 and the second one of the resources 128. In another example, resource managing component 112 can similarly also open another network port (e.g., the same network port) on the second one of the resources 128. Where the desired workspace configuration indicates a port number, resource managing component 112 can open the network port having the port number. In other examples, resource managing component 112 can open a default port number.

In another example, in configuring the resources to communicate with one another at action 514, optionally at action 518, a security protocol to be used in communicating using the network port can be configured. In an example, resource managing component 112 of the workspace provisioning component 108, e.g., in conjunction with processor 102, memory 104, operating system 106, etc., can configure the security protocol to be used in communicating using the network port. For example, workspace provisioning component 108 can establish, at a first one of the resources, a security session with a second one of the resources using the security protocol over the network port. In this regard, the resources can use the security protocol in communicating with one another. Where the desired workspace configuration indicates the security protocol, resource managing component 112 can cause the resources to establish the session over the network port using the security protocol. In other examples, resource managing component 112 can setup a default security protocol for communicating over the network port.

In method 500, optionally at action 520, an indication of one or more parameters for accessing the multiple resources via the cloud-based computing platform can be provided to the user interface. In an example, workspace provisioning component 108, e.g., in conjunction with processor 102, memory 104, operating system 106, etc., can provide, to the user interface (e.g., provided via interface component 132), the indication of one or more parameters for accessing the multiple resources (e.g., resources 128) via the cloud-based computing platform 120. For example, workspace provisioning component 108 can provide address or other identifying information for the resources in the cloud-based computing platform, credentials, tokens, security protocol type, etc. for communicating with the resources, etc. Thus, for example, the user can use the user interface to setup the desired workspace configuration, and the workspace provisioning component 108 can handle the deployment, as described herein, providing back to the user interface the information to access the resources that were deployed as desired. Thus, the user need not perform certain aspects of configuring the resources or the nodes deployed thereon, connectivity between the resources or associated nodes, etc., but rather can have the resources automatically deployed by the workspace provisioning component 108 and can use the resources based on the desired configuration once deployed (and/or once the parameters for accessing the resources have been received).

FIG. 7 is a flowchart of an example of a method 700 for managing deployed resources on a cloud-based computing platform. For example, method 700 can be performed by a device 100 and/or one or more components thereof, or other devices in a cloud-based computing platform 120, to facilitate deploying and/or managing resources or related connectivity.

In method 700, at action 702, the resources as deployed (e.g., using method 500) can be managed according to the desired workspace configuration. In an example, resource managing component 112 of a workspace provisioning component 108, e.g., in conjunction with processor 102, memory 104, operating system 106, etc., can manage the resources deployed according to the desired workspace configuration. This may include managing a lifetime for the resources, a QoS for the resources, and/or the like.

In one example, in managing the resources at action 702, optionally at action 704, at least one of the multiple resources can be removed from a corresponding one of the one or more nodes based on a timer. In an example, resource managing component 112 of a workspace provisioning component 108, e.g., in conjunction with processor 102, memory 104, operating system 106, etc., can remove at least one of the multiple resources from the corresponding one of the one or more nodes based on the timer. In one example, resource managing component 112 may also terminate or request or indicate termination of the resources. For example, the desired workspace configuration may indicate a lifespan of the resource or a start and/or end time for the resource. Accordingly, when the end time is reached, resource managing component 112 can remove the resource or otherwise terminate the associated workload or process, which can result in cost savings otherwise caused by keeping the resource running.

In an example, removing the resources can also be based on a performance configuration assigned for deploying the at least one of the multiple resources. For example, the performance configuration may be assigned to the resources via the user interface or may otherwise relate to one or more policies configured for the user or the user group to which the user belongs, corporate entity or division, etc. on the cloud-based computing platform. For example, the performance configuration can specify machine-specific parameters (e.g., VM-specific parameters, node-specific parameters, etc.) for executing the or deploying the resources. For example, the performance configuration can specify a number of processors, an amount of memory, and an amount of disk space for deploying the at least one of the multiple resources. In some cloud-based computing platforms, the performance configuration can correspond to a subscription level, SKU, etc. In an example, resource managing component 112 can remove the resources from one or more nodes based on determining that removing the resources is cost-effective in view of the performance configuration, a cost for deploying the resources with the performance configuration, and/or the like.

In one example, in managing the resources at action 702, optionally at action 706, at least one of the multiple resources can be moved to a different node. In an example, resource managing component 112 and/or resource governance component 114 of a workspace provisioning component 108, e.g., in conjunction with processor 102, memory 104, operating system 106, etc., can move the at least one of the multiple resources to a different node. For example, resource managing component 112 and/or resource governance component 114 can move the resource where the resource or associated node is failing or otherwise has constrained throughput. In another example, resource managing component 112 and/or resource governance component 114 can move the resource to load balance resources over multiple nodes, to comply with one or more quota parameters, etc. The moving can be agnostic, however, to the client or device that requested the workspace, and the resource managing component 112 and/or resource governance component 114 can manage the resources such that the moved resource has the same or similar access procedures as before moving. In another example, resource managing component 112, resource governance component 114, and/or firewall component 118 can update firewall settings based on moving the resources to allow the user to access the resource on the underlying one or more nodes. In one example, where the resource has defined network connectivity in the desired workspace configuration, resource managing component 112, resource governance component 114 can additionally setup the network connectivity for the moved resource (e.g., on the different node), which may include opening a network port on the different node, etc.

In an example, moving the resources can also be based on a performance configuration assigned for deploying the at least one of the multiple resources. For example, the performance configuration may be assigned to the resources via the user interface or may otherwise relate to one or more policies configured for the user or the user group to which the user belongs, corporate entity or division, etc. on the cloud-based computing platform. In an example, resource managing component 112 can move the resources from one or more nodes to one or more other nodes based on determining that moving the resources is cost-effective in view of the performance configuration, a cost for deploying the resources with the performance configuration, and/or the like. For example, resource managing component 112 can move the resources to a different region or based on a different performance configuration where moving is determined to be cost effective, which may be in view of subscription parameters of the user, user group, corporation, etc.

In one example, in managing the resources at action 702, optionally at action 708, one or more maintenance operations of the multiple resources can be managed. In an example, resource managing component 112 and/or resource compliance component 116 of a workspace provisioning component 108, e.g., in conjunction with processor 102, memory 104, operating system 106, etc., can manage one or more maintenance operations on the multiple resources. For example, resource managing component 112 and/or resource compliance component 116 can update or patch the software (e.g., the software or image version or other software updates) on the multiple resources without information or request from the desired workspace configuration or from the user. Thus, managing the maintenance operations can be automatically performed without requiring user interaction. In another example, resource managing component 112 and/or resource compliance component 116 can apply a resource specific security configuration to the multiple resources. The resource specific security configuration can include parameters for General Data Protection Regulation (GDPR)-based compliance, encryption of data, applying outbound call restrictions, etc.

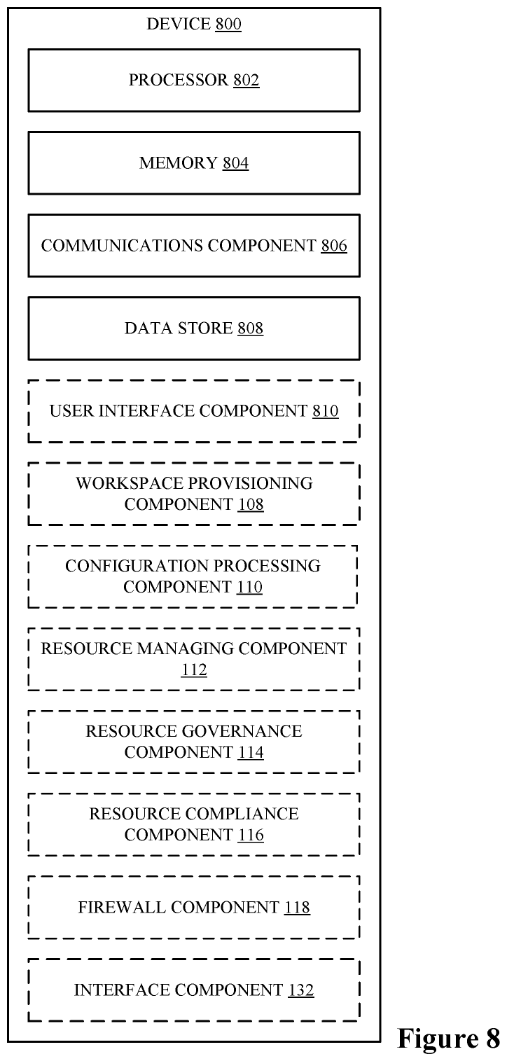

FIG. 8 illustrates an example of device 800 including additional optional component details as those shown in FIG. 1. In one aspect, device 800 may include processor 802, which may be similar to processor 102 for carrying out processing functions associated with one or more of components and functions described herein. Processor 802 can include a single or multiple set of processors or multi-core processors. Moreover, processor 802 can be implemented as an integrated processing system and/or a distributed processing system.

Device 800 may further include memory 804, which may be similar to memory 104 such as for storing local versions of operating systems (or components thereof) and/or applications being executed by processor 802, such as a workspace provisioning component 108, configuration processing component 110, resource managing component 112, resource governance component 114, resource compliance component 116, firewall component 118, interface component 132, etc. Memory 804 can include a type of memory usable by a computer, such as random access memory (RAM), read only memory (ROM), tapes, magnetic discs, optical discs, volatile memory, non-volatile memory, and any combination thereof.

Further, device 800 may include a communications component 806 that provides for establishing and maintaining communications with one or more other devices, parties, entities, etc. utilizing hardware, software, and services as described herein. Communications component 806 may carry communications between components on device 800, as well as between device 800 and external devices, such as devices located across a communications network and/or devices serially or locally connected to device 800. For example, communications component 806 may include one or more buses, and may further include transmit chain components and receive chain components associated with a wireless or wired transmitter and receiver, respectively, operable for interfacing with external devices.

Additionally, device 800 may include a data store 808, which can be any suitable combination of hardware and/or software, that provides for mass storage of information, databases, and programs employed in connection with aspects described herein. For example, data store 808 may be or may include a data repository for operating systems (or components thereof), applications, related parameters, etc.) not currently being executed by processor 802. In addition, data store 808 may be a data repository for a workspace provisioning component 108, configuration processing component 110, resource managing component 112, resource governance component 114, resource compliance component 116, firewall component 118, interface component 132, and/or one or more other components of the device 800.

Device 800 may optionally include a user interface component 810 operable to receive inputs from a user of device 800 and further operable to generate outputs for presentation to the user. User interface component 810 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 810 may include one or more output devices, including but not limited to a display, a speaker, a haptic feedback mechanism, a printer, any other mechanism capable of presenting an output to a user, or any combination thereof. Moreover, for example, user interface component 810 may include or allow interaction with interface component 132.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A computer-implemented method for provisioning resources on a cloud-based computing platform, comprising:
receiving, from a user interface, a visual representation of a desired workspace configuration including multiple resources to be deployed on the cloud-based computing platform, wherein the visual representation includes an indication of communication between two or more of the multiple resources;
translating the visual representation into a data representation including name/value pairs;
deploying, based on the data representation, the multiple resources on one or more nodes of the cloud-based computing platform;
configuring, based on the indication of communication, network connectivity between two or more of the multiple resources; and
providing, to the user interface, an indication of one or more parameters for accessing the multiple resources via the cloud-based computing platform.

2. The computer-implemented method of claim 1, further comprising removing at least one of the multiple resources from a corresponding one of the one or more nodes based on a timer specified in the desired workspace configuration.

3. The computer-implemented method of claim 1, further comprising assigning, to at least one of the multiple resources, a performance configuration for deploying the at least one of the multiple resources, wherein the performance configuration specifies a number of processors, an amount of memory, and an amount of disk space for the at least one of the multiple resources.

4. The computer-implemented method of claim 1, further comprising moving one of the multiple resources to a different node of the cloud-based computing platform to comply with a resource governance quota, wherein the moving is agnostic to the user interface and the desired workspace configuration.

5. The computer-implemented method of claim 4, wherein moving the one of the multiple resources includes determining the different node based on a performance configuration assigned for deploying the at least one of the multiple resources, wherein the performance configuration specifies a number of processors, an amount of memory, and an amount of disk space for the at least one of the multiple resources.

6. The computer-implemented method of claim 1, further comprising managing one or more compliance operations on the multiple resources, wherein the one or more compliance operations includes managing access to the multiple resources, or applying a patch or security update or resource specific security configuration to the multiple resources or the one or more nodes.

7. The computer-implemented method of claim 1, wherein deploying the multiple resources includes configuring at least a portion of the multiple resources based on a software configuration indicated in the desired workspace configuration.

8. (canceled)

9. The computer-implemented method of claim 1, wherein configuring the network connectivity includes opening a network port on at least one of the resources to facilitate communicating with at least another one of the resources.

10. The computer-implemented method of claim 9, further comprising configuring a security protocol to be used in communicating using the network port, wherein the security protocol is agnostic to the desired workspace configuration.

11. The computer-implemented method of claim 1, wherein the desired workspace configuration indicates a geographic region, and wherein deploying the multiple resources includes deploying the multiple resources on one or more nodes that are located in the geographic region.

12. The computer-implemented method of claim 1, wherein the user interface allows for selecting the each of the multiple resources for adding to the visual representation of the desired workspace configuration.

13. The computer-implemented method of claim 12, wherein the user interface allows for indicating the visual connection between the two or more of the multiple resources to indicate the network connectivity between the two or more of the multiple resources.

14. A device for provisioning resources on a cloud-based computing platform, comprising:
a memory storing instructions; and
at least one processor coupled to the memory and configured to execute the instructions to:
receive, from a user interface, a visual representation of a desired workspace configuration including multiple resources to be deployed on the cloud-based computing platform, wherein the visual representation includes an indication of communication between two or more of the multiple resources;
translate the visual representation into a data representation including name/value pairs;
deploy, based on the data representation, the multiple resources on one or more nodes of the cloud-based computing platform;
configure, based on the indication of communication, network connectivity between two or more of the multiple resources; and
provide, to the user interface, an indication of one or more parameters for accessing the multiple resources via the cloud-based computing platform.

15. The device of claim 14, wherein the at least one processor is further configured to execute the instructions to remove at least one of the multiple resources from a corresponding one of the one or more nodes based on a timer specified in the desired workspace configuration.

16. The device of claim 14, wherein the at least one processor is further configured to execute the instructions to assign, to at least one of the multiple resources, a performance configuration for deploying the at least one of the multiple resources, wherein the performance configuration specifies a number of processors, an amount of memory, and an amount of disk space for the at least one of the multiple resources.

17. The device of claim 14, wherein the at least one processor is further configured to execute the instructions to move one of the multiple resources to a different node of the cloud-based computing platform to comply with a resource governance quota, wherein the moving is agnostic to the user interface and the desired workspace configuration, wherein the at least one processor is configured to execute the instructions to move the one of the multiple resources at least in part by determining the different node based on a performance configuration assigned for deploying the at least one of the multiple resources, wherein the performance configuration specifies a number of processors, an amount of memory, and an amount of disk space for the at least one of the multiple resources.

18. The device of claim 14, wherein the at least one processor is further configured to execute the instructions to manage one or more compliance operations on the multiple resources, wherein the one or more compliance operations includes managing access to the multiple resources, or applying a patch or security update or resource specific security configuration to the multiple resources or the one or more nodes.

19. A non-transitory computer-readable medium storing instructions thereon that, when executed by at least one computing device, causes the at least one computing device to perform operations for provisioning resources on a cloud-based computing platform, comprising:
receiving, from a user interface, a visual representation of a desired workspace configuration including multiple resources to be deployed on the cloud-based computing platform, wherein the visual representation includes an indication of communication between two or more of the multiple resources;
translating the visual representation into a data representation including name/value pairs;
deploying, based on the data representation, the multiple resources on one or more nodes of the cloud-based computing platform;
configuring, based on the indication of communication, network connectivity between two or more of the multiple resources; and
providing, to the user interface, an indication of one or more parameters for accessing the multiple resources via the cloud-based computing platform.

20. The non-transitory computer-readable medium of claim 19, the operations further comprising removing at least one of the multiple resources from a corresponding one of the one or more nodes based on a timer specified in the desired workspace configuration.

21. The device of claim 14, wherein the at least one processor is configured to deploy the multiple resources by configuring at least a portion of the multiple resources based on a software configuration indicated in the desired workspace configuration.
